(19) United States
(12) Patent Application Publication
(10) Pub. No.: US 2026/0111775 A1
(43) Pub. Date: Apr. 23, 2026

(54) Methods For Using Quantum Computers

(71) Applicant: Quantinuum Ltd., London (GB)

(72) Inventors: Steven Herbert, London (GB); Michael Spranger, London (GB)

(73) Assignee: Quantinuum Ltd., London (GB)

(21) Appl. No.: 18/998,150

(22) PCT Filed: Jul. 26, 2023
(86) PCT No.: PCT/GB2023/051982

§ 371 Date: Jan. 24, 2025

(30) Foreign Application Priority Data
Jul. 27, 2022 (GB) 2210997.9
Feb. 1, 2023 (GB) 2301481.4

(51) Int. Cl. G06N 10/20; G06N 10/40; G06N 10/60

(52) U.S. Cl. CPC G06N 10/20; G06N 10/40; G06N 10/60

(57) ABSTRACT

There is provided a series of steps, according to user-defined instructions, that enhance a quantum state preparation circuit encoding some multivariate probability distribution such that the circuit further includes dimensions pertaining to sums, products and maxima/minima of other dimensions, and optionally includes a further “flag” qubit that will act as a conditional control in quantum Monte Carlo integration (QMCI). The series of steps are useful for computations in many applications in science and engineering.

### TECHNICAL FIELD

The present disclosure relates to methods for using quantum computers, in particular to methods for using an enhanced state preparation circuit builder for generating quantum circuits for execution on quantum computing hardware for summing, multiplying and taking maxima/minima of correlated random variables and encoding threshold conditions in an amplitude of a qubit. Moreover, the present disclosure is also concerned with software products for execution on quantum computing hardware for implementing the aforesaid methods.

### BACKGROUND

Quantum computers are inherently suitable for determining properties of complex physical systems and computational systems, because they exploit quantum phenomena. Unlike classical digital computers in which the basic unit of computation, the bit, has in one of two discrete binary states (1 or 0), quantum computers utilise qubits which may exist in a superposition of many different computational states. This allows a quantum computer to investigate many different states in parallel. However, quantum computers are vulnerable to noise which may lead to decoherence between the different quantum states. This noise problem becomes more significant as the number of qubits increases for more complex computational processing.

Monte Carlo methods use random sampling to estimate numerical properties of systems which are too large or too complex to analyze deterministically. It is known that quantum computers can be configured to perform quantum Monte Carlo integration (QMCI). QMCI has many applications in science and engineering, including for simulating and analyzing complex quantum systems such as molecular structures. In a European patent application EP22159844.4 (published as EP4053756) and in a U.S. patent application Ser. No. 17/684,254 (published as US2023/036827), which are incorporated herein by reference, various methods of quantum Monte Carlo integration are described.

According to a first aspect, there is provided a computer implemented method for generating a quantum circuit for use by a quantum computing apparatus to prepare a state therein that encodes a target multivariate probability distribution, wherein the method includes steps of:
(i) receiving first input data defining a quantum circuit P for encoding the target probability distribution onto a state of one or more qubits;
(ii) receiving second input data defining the number of one or more dimensions (d) of the target probability distribution;
(iii) receiving third input data defining a number of one or more qubits corresponding to the one or more dimensions (d) of the target probability distribution;
(iv) receiving fourth input data defining a support for each dimension of the d dimensions of the target probability distribution;
(v) generating from the first, second, third, and fourth data an enhanced form of the quantum circuit; and
(vi) outputting data defining the enhanced quantum circuit;
   wherein the sum of the numbers of qubits corresponding to each dimension is equal to the number of the one or more qubits of the state that the target probability distribution is encoded onto by circuit P, and wherein generating the enhanced quantum circuit in step (v) includes at least one of:
(a) generating additional quantum circuitry for the quantum circuit based on the input data of steps (i)-(iv) to sum random variables of the target probability distribution to encode the sum as a new dimension of the multivariate distribution;
(b) generating additional quantum circuitry for the quantum circuit based on the input data of steps (i)-(iv) to calculate a product of a plurality of random variables of the target probability distribution and to encode the product as a new dimension of the multivariate distribution;
(c) generating additional quantum circuitry for the quantum circuit based on the input data of steps (i)-(iv) to calculate at least one of a maximum and a minimum of two correlated random variables represented as dimensions of the multivariate distribution and to encode each of the at least one of the maximum and minimum as a new dimension of the multivariate distribution; or
(d) generating additional quantum circuitry for the quantum circuit based on the input data of step (i)-(iv) to check if a threshold condition is satisfied by a single random variable represented as one dimension of the multivariate distribution and to encode the result of the check on at least one extra truth qubit.

Steps (a) to (d) may occur in any combination and any order and there may be a plurality of instances of each step.

The enhanced quantum circuit can be generated on a classical (digital) computer system and is then implementable and executable on a quantum computing apparatus, for example for efficiently performing Monte Carlo Integration for various scientific computations, such as for estimation of numerical properties of physical systems and forecasting, via high-dimensional integration results of sampled random variables from multivariate probability distributions. The enhanced quantum circuits can be executed on quantum computing hardware for summing, multiplying and taking maxima/minima of random variables and encoding threshold conditions in an amplitude of a qubit, for evaluation of quantum systems. Many applications of quantum Monte Carlo integration (QMCI) that involve computation of advanced functions can be implemented by dividing computing tasks between a classical computer and a quantum computer, wherein the classical computer and the quantum computer are configured to function as a hybrid computing arrangement. Such advanced functions can include integration as well as detection of maxima and minima, and can compute whether or not one or more thresholds have been traversed.

The invention is of advantage in that there is provided a series of steps, according to user-defined instructions, that enhance a quantum state preparation circuit encoding some multivariate probability distribution such that the circuit further includes dimensions pertaining to one or more of sums, products and maxima/minima of other dimensions, or threshold determinations such as whether a first value is greater or smaller than a second value. The data that is used to generate the enhanced circuit includes data defining a quantum circuit P for encoding the target probability distribution onto a state of one or more qubits, and metadata describing how the state prepared by the circuit P is to be interpreted as a probability distribution, including a set of parameters for each of the d dimensions of the probability distribution. This metadata is provided to or generated within the computer system that is generating the enhanced quantum circuit. The information about how to interpret the state prepared by P may include:
how many dimensions the multivariate distribution has;
how many qubits represent each dimension; and
for each dimension, a value for the minimum point of probability mass and the spacing between points.

The circuit optionally includes one or more further indicator qubits (referred to herein as “flag” qubits) that will act as conditional controls in quantum Monte Carlo integration (QMCI).

The inventors of the present invention have determined that quantum circuits can be generated and executed on a quantum computer with larger numbers of dimensions than would be efficiently implementable using classical numerical integration methods (including classical Monte Carlo integration), offering a quantum advantage in principle. In particular, the methods and systems described herein are adapted for generating enhanced quantum circuits for computations involving non-linear functions, for many different systems and processes that can be represented as quantum states. Classical numerical integration methods are less well suited for high-dimensional integrals involving non-linear functions. Various optimisations are described below to retain relatively shallow quantum circuits and provide computational efficiency using currently available quantum computer systems.

In one implementation, a set of user-selectable operations are predefined within a modular QMCI engine that controls generation of the quantum circuits. The series of steps for generating an enhanced quantum circuit can be performed on a classical binary computer system to generate a quantum circuit for use by a quantum computing apparatus to prepare a state therein that encodes a target multivariate or univariate probability distribution. The enhanced quantum circuits generated by the steps described in this specification can be used for computations in many technical fields such as computational chemistry, high energy physics and astrophysics (for example, processing satellite-collated images) and other fields of science and engineering, as well as for financial QMCI computations.

Optionally, in the method, step (d) of generating threshold quantum circuitry to check if a threshold condition is satisfied is performed for a plurality of different single random variables with a corresponding threshold condition and wherein step (v) of generating the enhanced quantum circuit further comprises:
generating additional threshold quantum circuitry for the quantum circuit based on the input data of step (i)-(iv) to add at least one further flag qubit to provide additional conditional control. In an example, the at least one further flag qubit is computed from an exclusive sum of products (ESOP) of each truth value of a plurality subset of the plurality of extra truth qubits, such that the computation result may be conditional on any one or any subset of the plurality of truth qubits.

Optionally, in the method, the quantum circuit P is configured for implementing quantum Monte Carlo integration (QMCI).

Optionally, in the method, there is a plurality of the dimensions (d).

Optionally, in the method, the summing in step (a) is implemented using a binary adder circuit. Optionally, in the method, step (vi) also comprises outputting first additional data defining the number of dimensions of the enhanced multivariate distribution, including any new dimension of steps (a)-(d), and second additional data defining a number of one or more qubits corresponding to each dimension of the enhanced multivariate distribution, and third additional data defining a support for each dimension of the enhanced multivariate distribution. Optionally, the data is output from a first classical computer that is generating the enhanced quantum circuit to a second classical computer for extra processing. This extra processing could be before or after execution of the enhanced quantum circuit on a quantum computer.

According to a second aspect, there is provided a quantum computing apparatus configured to receive data defining the enhanced quantum circuit that is generated using the method of any one of claims 1 to 6, and to implement the received enhanced quantum circuit that is generated using the method of the first aspect.

According to a third aspect, there is provided a system for generating quantum circuits, the system comprising:
a memory; and
a processor, wherein the processor is configured to perform the steps of:
(i) receiving first input data defining a quantum circuit P for encoding the target probability distribution onto a state of one or more qubits;
(ii) receiving second input data defining the number of one or more dimensions (d) of the target probability distribution;
(iii) receiving third input data defining a number of one or more qubits corresponding to each dimension of the d dimensions of the target probability distribution;
(iv) receiving fourth input data defining a support for each dimension of the d dimensions of the target probability distribution;
(v) generating from the first, second, third, and fourth data an enhanced form of the quantum circuit; and
(vi) outputting data defining the enhanced quantum circuit;
wherein the sum of the numbers of qubits corresponding to each dimension is equal to the number of the one or more qubits of the state that the target probability distribution is encoded onto by circuit P, and wherein generating the enhanced quantum circuit in step (v) includes at least one of:
(a) generating additional quantum circuitry for the quantum circuit based on the input data of steps (i)-(iv) to sum random variables of the target probability distribution and to encode the sum as a new dimension of the multivariate distribution;
(b) generating additional quantum circuitry for the quantum circuit based on the input data of steps (i)-(iv) to calculate a product of a plurality of random variables of the target probability distribution and to encode the product as a new dimension of the multivariate distribution;
(c) generating additional quantum circuitry for the quantum circuit based on the input data of steps (i)-(iv) to calculate at least one of a maximum and a minimum of two correlated random variables represented as dimensions of the multivariate distribution and to encode each of the at least one of the maximum and minimum as a new dimension of the multivariate distribution; or
(d) generating additional threshold quantum circuitry for the quantum circuit based on the input data of step (i)-(iv) to check if a threshold condition is satisfied by a single random variable represented as one dimension of the multivariate distribution and to encode the result of the check on at least one extra truth qubit.

Optionally, in the system, step (d) of generating threshold quantum circuitry to check if a threshold condition is satisfied is performed for a plurality of different single random variables with a corresponding threshold condition and wherein step (v) of generating the enhanced quantum circuit further comprises:
generating additional threshold quantum circuitry for the quantum circuit based on the input data of step (i)-(iv) to add at least one further flag qubit, wherein the at least one further flag qubit is computed from an exclusive sum of products (ESOP) of each truth value of a plurality subset of the plurality of extra truth qubits.

Optionally, in the system, the quantum circuit P is configured for implementing quantum Monte Carlo integration (QMCI).

Optionally, in the system, there is a plurality of the dimensions (d).

Optionally, in the system, the additional quantum circuit includes a binary adder circuit for implementing summing in (a).

Optionally, in the system, step (vi) also comprises outputting first additional data defining the number of dimensions of the enhanced multivariate distribution, including any new dimension of steps (a)-(d), and second additional data defining a number of one or more qubits corresponding to each dimension of the enhanced multivariate distribution, and third additional data defining a support for each dimension of the enhanced multivariate distribution, and optionally, the data is output to a further classical computer for extra processing.

According to a fourth aspect, there is provided a system comprising the system of the third aspect and further comprising a quantum computing apparatus configured to receive from the processor the data defining the enhanced quantum circuit and to implement the enhanced quantum circuit based on the received data.

According to a fifth aspect, there is provided a software product that is executable upon the computer system of the third aspect, to implement the method of the first aspect.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### DESCRIPTION OF DIAGRAMS

Example implementations of the disclosed invention are described below in more detail, with reference to the following diagrams:

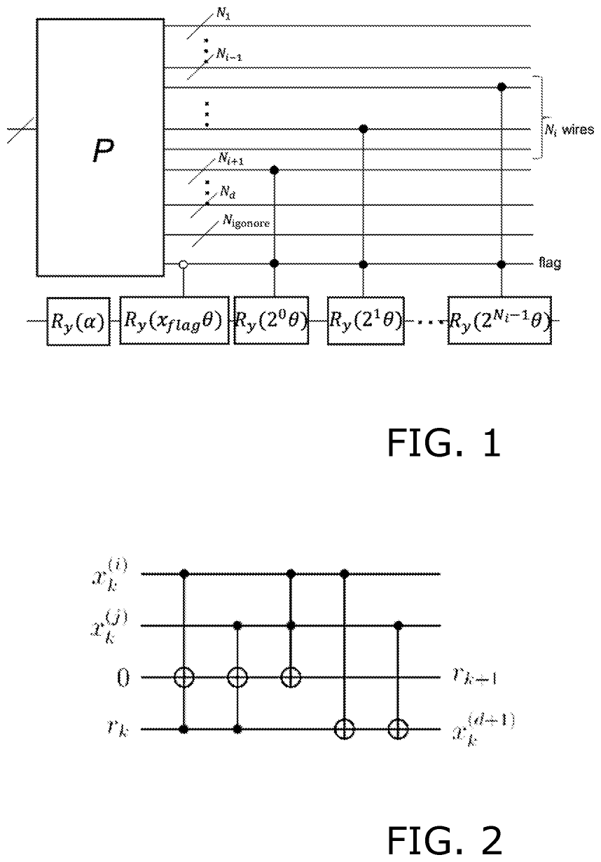

FIGS. 1 to 16 are depictions of quantum circuits that are executable on quantum computing hardware (or a quantum computing hardware emulator) for implementing embodiments of the present disclosure.

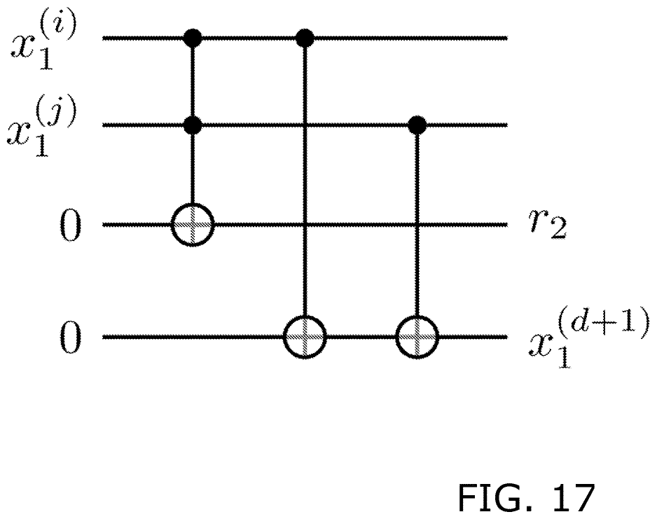

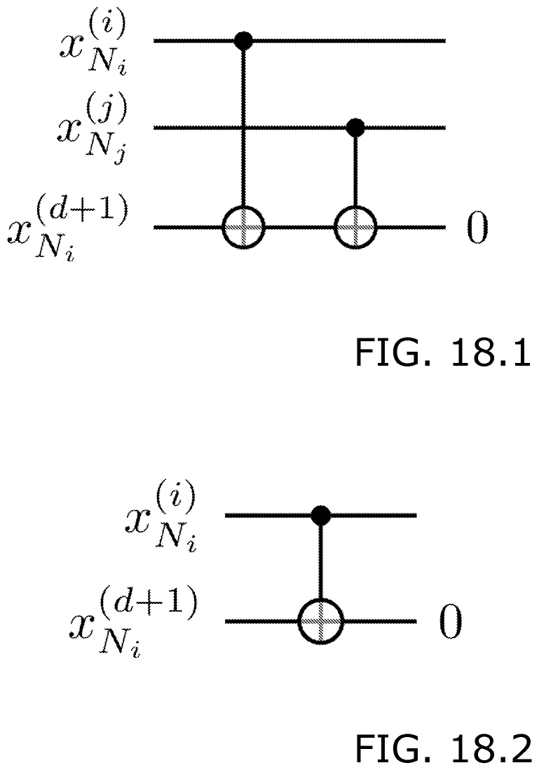

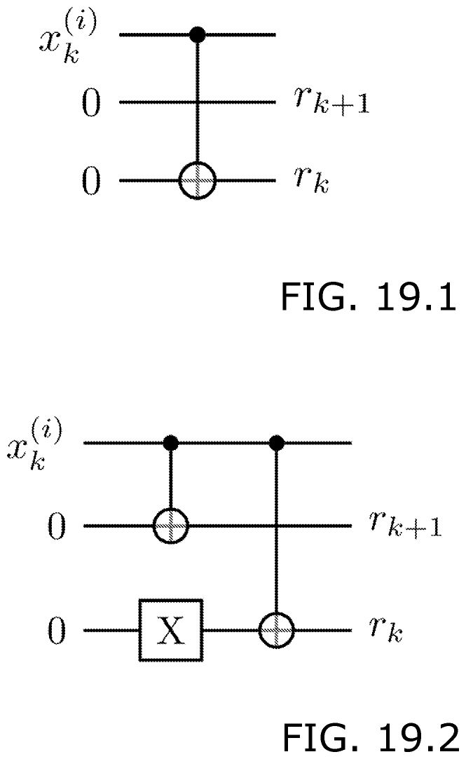

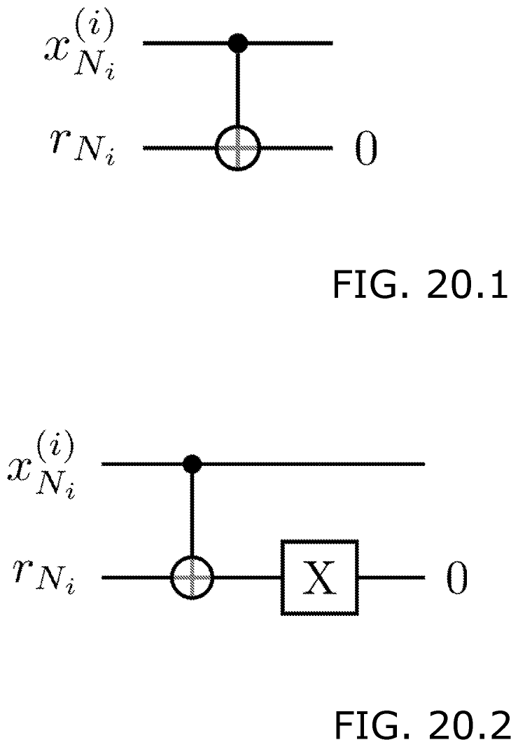

FIG. 17, FIGS. 18.1 and 18.2, FIGS. 19.1 and 19.2, and FIGS. 20.1 and 20.2 depict optimisations of quantum circuits according to alternative implementations of the invention.

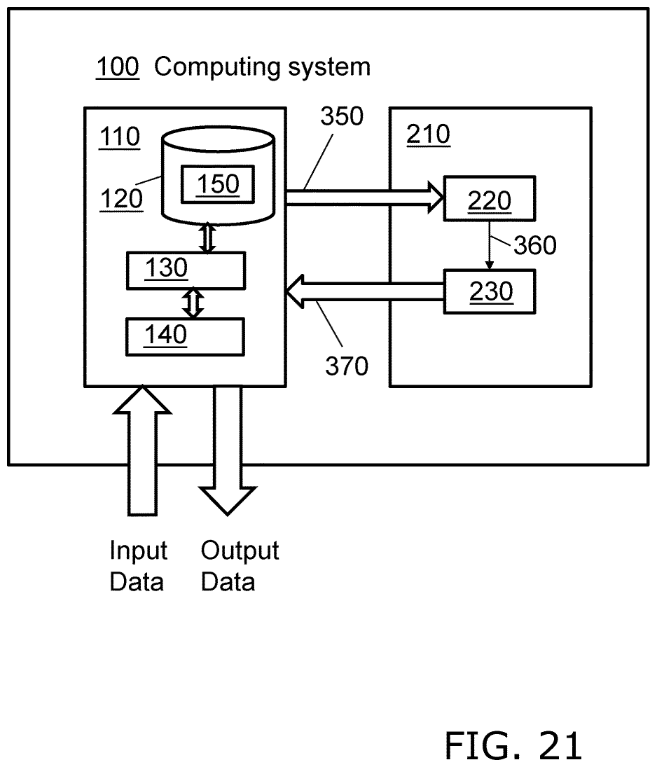

FIG. 21 is a schematic representation of a computing system including a classical (binary) computing apparatus and a quantum computing apparatus.

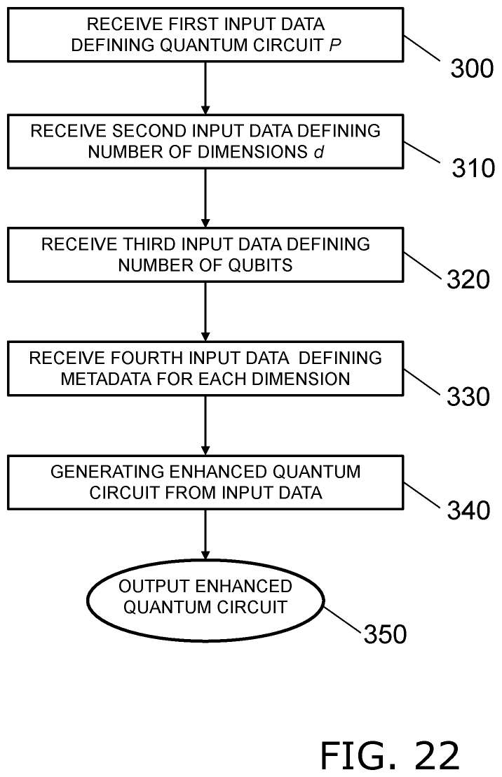

FIG. 22 shows a series of steps of a method as described herein.

In the accompanying diagrams, an underlined number is employed to represent an item over which the underlined number is positioned or an item to which the underlined number is adjacent. When a number is non-underlined and accompanied by an associated arrow, the non-underlined number is used to identify a general item at which the arrow is pointing.

### DETAILED DESCRIPTION OF EMBODIMENTS

### 1 Introduction and Motivation

Every quantum state can be interpreted as an encoding of a probability distribution—most notably when said state is measured in the computational basis, and thus a given bitstring is sampled with probability equal to the squared amplitude of the corresponding term when the state is expressed as a superposition of computational basis states. Preparing states that deliberately encode particular target distributions is an important task in many quantum algorithms, in particular in quantum Monte Carlo integration (QMCI) (see for example [Ref1],[Ref2]).

We use ‘P’ to denote a circuit that prepares a state, |p>, that is |p>=P|0> (where 0 signifies an appropriate number of qubits in the zero state), which is interpreted as an encoding of a multivariate probability distribution:

$$\vert p 〉 = {\sum }_{\begin{matrix}{∞}^{( 1 )} ∈ {\{ 0 , 1 \}}^{{N}_{1}} \\ ⋮ \\ {∞}^{( d )} ∈ {\{ 0 , 1 \}}^{{N}_{d}}\end{matrix}} \sqrt{p ( {x}^{( 1 )} , … , {x}^{( d )} )} \vert {x}^{( 1 )} … {x}^{( d )} 〉 \qquad ( 1 )$$

In order for such a prepared state to be correctly interpreted as an encoding of a probability distribution, we supply the following additional information:
1. The number of dimensions of the probability distribution, denoted d (univariate, d=1, is a special case).
2. The number of qubits corresponding to each dimension, denoted N₁, N₂, . . . , N_{d}.
3. The support of each dimension. For the i^{th} dimension,

$${x}_{l}^{( i )}$$

is a real number that denotes the minimum supported value; and Δ⁽ⁱ⁾ is a real number that denotes the spacing between points of probability mass.

Formally, in order to specify a state preparation circuit, as well as the circuit itself it is necessary to specify ‘meta-data’ describing how the state prepared by P is to be interpreted as a probability distribution. This meta-data consists of Δ, xₗ, N which are respectively d-length vectors of

$${Δ}^{( i )} , {x}_{l}^{( i )} , {N}_{i} ;$$

d is therefore implicitly defined as the length of these other inputted terms.

The circuit P is typically treated as an input in QMCI, however it has been shown that it is always possible to construct a suitable circuit from the corresponding classical sampling algorithm [Ref3]. We therefore proceed assuming that a suitable circuit P has been constructed, and the accompanying meta-data is also included as an input. For the sake of definiteness, in the following exposition we use a simple example of random processes used in finance, however it will be appreciated that the following applies to any other application of Monte Carlo integration such as in scientific and engineering applications. In many financial applications of Monte Carlo integration, the various dimensions of the multivariate distribution pertain to financial time-series data sliced up at (typically regular) intervals. The financial time-series data is the price (or the logarithm of the price) of some ‘underlying’ and in general many correlated underlyings may be included in the same multivariate distribution (each time-series sliced at the same intervals). Suitable models for such multivariate distributions include multivariate normals and log normals, as well as stochastic time-series models such as autoregressive (AR) models, autoregressive moving-average (ARMA) models, hidden Markov models and machine learning generative models trained on historic time-series data, amongst others.

Monte Carlo integration is then used to numerically approximate the price of certain derivative instruments which depend on the underlyings, and various measures of risk pertaining to ‘portfolios’ containing the various financial instruments (potentially including derivatives). Typically, such Monte Carlo integrals are not simple expectations of the random variables, but rather depend on certain threshold conditions. Furthermore, the expectation may be of the sum, average or max/min of some number of random variables pertaining to various dimensions of the multivariate probability distribution (note that average is essentially the same as sum for our purposes, as the sum will differ only by a known constant factor from the average—and this constant factor can easily be accounted for classically).

In order to enable any logical function of the values (that is true or false) of the various threshold conditions, an optional further qubit is added to act as a condition on any expectation value computed in QMCI, and we further specify in the information that accompanies P:
4. Whether this optional qubit is present.

Thus we extend the meta-data to include ‘flag’, which is a ‘bool’ that is true when the optional qubit is present, and false otherwise. There is also, in general, the possibility that P may now contain further qubits that are neither the flag qubit nor pertain to the registers of the multivariate distribution, however in our current embodiment the explicit declaration of the multivariate dimensions (and their sizes) and of whether there is a flag qubit means that this information can be left implicit.

In this description we propose a method that takes some input circuit P, along with its original meta-data and flag=0 and returns some enhanced version of P (with possible further dimensions corresponding to max/min and sums of the dimensions, as specified by the user), along with an accordingly updated set of meta-data, and may have flag=0 or flag=1.

This additional qubit simply acts as a control qubit on the QMCI circuitry, and so it is simple to incorporate this additional degree of freedom into any QMCI. In the case of Fourier QMCI [Ref1], the circuits generated would be of the form as illustrated in FIG. 1, where the N_{ignore} qubits are the extra qubits that are neither those pertaining to the dimensions of the multivariate probability distribution, nor the flag qubit.

Such an enhanced circuit P is therefore constructed in response to data inputs including a user selection of desired functions to allow the user to programme any calculation where the quantity to be calculated depends on: sums and maxima/minima of the correlated random variables; as well as optionally conditioned on a further qubit, which is itself a function of the values (true of false) of one or more thresholds. This concept is developed and detailed in full in the next section. Referring to our relatively simple example of financial calculations, most of the common financial derivatives are covered by this framework:

| | Quantumly | |
|---|---|---|
| | applied | |
| Calculation | functions | Thresholds |
| European option | na | On the asset value itself |
| American option^{[1]} | na | At each timestep, depending on |
| | | optimal strategy |
| Bermudan option^{[1]} | na | Like American with discrete time |
| | | model |
| Barrier option | na | At each time step (knock in / |
| | | knock out) |
| Chooser option | na | One (or more) to decide whether |
| | | call / put |
| Binary^{[2]} | na | Various |
| Asian options | Average | Like a European option on the |
| | | average |
| Look back options | Max / min | Like a European option on the |
| | | max / min |
| Baskets of options | Sum^{[3]} | Can be a basket of any of the |
| | | other options here |

^{[1]}A first implementation of a QMCI engine provides an estimation tool, rather than an optimisation tool. In that implementation, it is only possible to compute the payoff for American and Bermudian options when some strategy on when to exercise the option is pre-defined. For instance, the QMCI engine can be called within a classical optimisation loop to find the best strategy.
^{[2]}Binary has been included as a row in its own right, but in practice you could have a binary version of virtual any derivative you may construct.
^{[3]}For a basket of options, the weights of the various items in the basket may not be equal. Thus, in order to simply sum bit values, we adjust the Δ for each dimension such that the bitstring sum implicitly includes the correct weights.

The method for achieving this presented herein places restrictions on the encoding of the support of the various dimensions of the multivariate distribution to achieve these through simple binary operations (specifically the reversible versions thereof). This means that the following should be taken not only as a series of steps for building a circuit, but also as a procedure for checking and consistently updating the meta-data describing P, such that the returned (enhanced) P is always valid and correct.

### 2 Technical Detail and Steps of the Method

### 2.1—Building a More Sophisticated Circuit P

A module that takes as input a circuit of type P, without flag qubits, and returns a circuit of type P, with or without flag qubits. The input circuit will, in general, have some d dimensions. As per the information concerning how to interpret P, each dimension will be assigned a number of wires, and xₗ and Δ.

Let the i^{th} random variable be denoted x⁽ⁱ⁾, so we have x⁽¹⁾, x⁽²⁾, . . . x^{(d)}. We then break down the construction into four parts.

### 2.2—Summing Random Variables

First we need a programming environment to allow the user to (reversibly sum) random variables such that the summed random variable appears as a new dimension of the multivariate distribution.

An instruction such as:
1 Sum(i, j)
(where i and j are distinct integers between 1 and d, inclusive) then involves the following steps:
   Check Δ⁽ⁱ⁾=Δ^{(j)} if not, then output an error message and stop.
Otherwise: Prepare a new (d+1)^{th} dimension of the multivariate distribution such that:

$${Δ}^{( d + 1 )} = {Δ}^{( i )}$$

$${x}_{l}^{( d + 1 )} = {x}_{l}^{( i )} + {x}_{l}^{( j )}$$

$${N}_{d + 1} = max ( {N}_{i} , {N}_{j} ) + 1 ( the number of wires for the new dimension ) .$$

We then append to P a reversible circuit to sum x⁽ⁱ⁾ and x^{(j)} and put the result as x^{(d+1)}. This can be done using a reversible binary adder circuit.
Finally, we set d←d+1

Any number of such sums are allowed to be performed, including on dimensions that were created in previous operations.

### 2.3—Multiplying Random Variables

We also permit the user to create new dimensions corresponding to the multiplication of two existing dimensions when the minimum points of probability mass are both 0.

An instruction such as:
1. Multiply (i, j)

(where i and j are distinct integers between 1 and d and, inclusive) then involves the following steps:
Check

$${x}_{l}^{( i )} = {x}_{l}^{( j )} = 0$$

if not, then output an error message and stop.

Otherwise prepare a new (d+1)^{th} dimension of the multivariate distribution such that:

$${Δ}^{( d + 1 )} = {Δ}^{( i )} \cdot {Δ}^{( j )}$$

$${x}_{l}^{( d + 1 )} = 0$$

$${N}_{d + 1} = {N}_{i} + {N}_{j}$$

We then append to P a reversible circuit to multiply x⁽ⁱ⁾ and x^{(j)} and put the result as x^{(d+1)}. This can be done using a reversible binary multiplication circuit.
Finally, we set d←d+1

Any number of such multiplications are allowed to be performed, including on dimensions that were created in previous operations.

### 2.4—Taking Maxima/Minima

We also permit the user to create new dimensions of the multivariate distribution corresponding to the maximum/minimum of two existing dimensions.

An instruction such as:
1. Max(i, j)
or
1. Min(i, j)
(where i and j are distinct integers between 1 and d, inclusive) then involves the following steps:
Check

$${x}_{l}^{( i )} = {x}_{l}^{( j )}$$

AND Δ⁽ⁱ⁾=Δ^{(j)} if not, then output an error message and stop.

Otherwise prepare a new (d+1)^{th} dimension of the multivariate distribution such that:

$${Δ}^{( d + 1 )} = {Δ}^{( i )}$$

$${x}_{l}^{( d + 1 )} = {x}_{l}^{( i )}$$

$${N}_{d + 1} = max ( {N}_{i} , {N}_{j} )$$

We then append to P a reversible circuit (which contains a control qubit with an implementation dependent final value) to take the maximum/minimum of x⁽ⁱ⁾ and x^{(j)} and put the answer as x^{(d+1)}. This can be achieved using similar circuitry as for the threshold (see below).
Finally we set d←d+1

### 2.5—Thresholds

The next step involves writing circuitry to compare the values of the various random variables to pre-set thresholds. The user will include instructions of the form:
1 Threshold(i, value, type)

Which means that the random variable in the i^{th} dimension will be compared to value. ‘type’ has a value of either ‘BoundType.Lower’ or ‘BoundType.Upper’—if it is ‘BoundType.Lower’, this means the threshold is satisfied if the random variable exceeds value; and if it is ‘BoundType.Upper’ it means the threshold is satisfied if value is equal or exceeds the random variable.

We now do the following:
Add a new set of Nᵢ+1 qubits to take the result of the subtraction of the value from x⁽ⁱ⁾. Since these qubits do not belong to a dimension, there needs no

$${x}_{l}^{( d + 1 )}$$

be associated.
Reversibly check the value of x⁽ⁱ⁾ against value by subtracting the latter from the former. In the case of ‘BoundType.Lower’, the most significant qubit will be set to one if the threshold condition is satisfied. For a ‘BoundType.Upper’ condition, this qubit needs to be inverted.

This can be repeated any number of times, but it is necessary to keep track of the qubits that have been added as ‘threshold qubits’ for the final step, below.

### 2.6—Preparation of the Flag Qubit

1. Append at least one further qubit (one or more indicator or ‘flag’ qubits);
2. The user should input a logical expression as an exclusive sum of products (ESOP) of the various threshold truth values prepared in the previous step.
3. Each product is then a multi-controlled not: the terms in the product as the conditions, and targeting the respective one of the qubits added in step one.
4. Doing the previous step for each term in the ESOP (each time targeting the same qubit) automatically achieves the exclusive sum.

Note that the order of sum, max/min and threshold is important. Maximum, minimum and sum operations can be called in any order, but these must all precede all of the threshold operations. The final user input is the logical expression depending on the threshold terms.

### 2.7—Reversible Sum

A circuit to take two registers, x⁽ⁱ⁾ and x^{(j)}, of sizes Nᵢ and Nⱼ respectively (where we let Nᵢ≥Nⱼ for simplicity) and outputs their sum, denoted x^{(d+1)} (which has Nᵢ+1 bits).

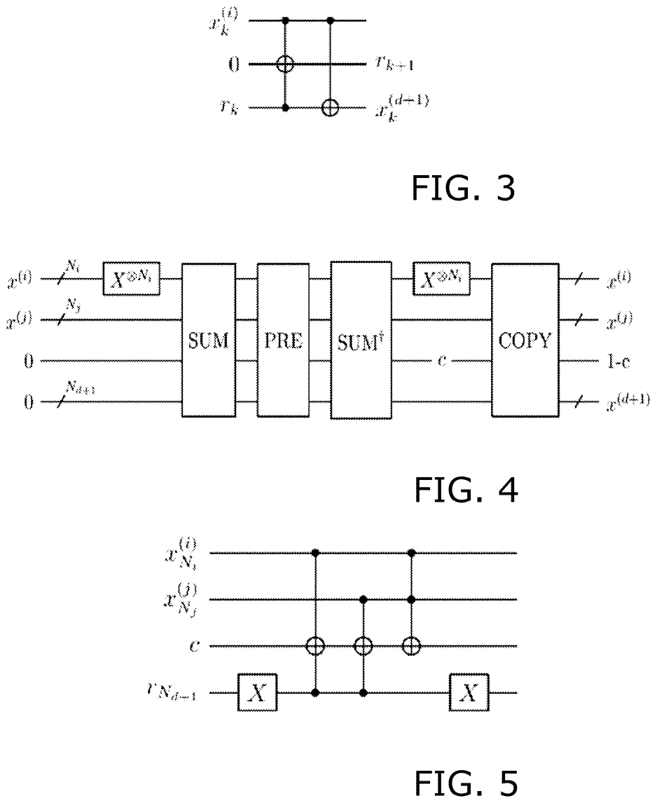

To do this, we can use Toffoli and CNOT gates to perform ‘in-place’ reversible sums. Let x⁽ⁱ⁾ and x^{(j)} be two numbers to be added (not necessarily using the same number of bits when represented in binary) to give x^{(d+1)}. The essential circuit for the case Nᵢ, Nᵢ≥k is then as illustrated in FIG. 2.

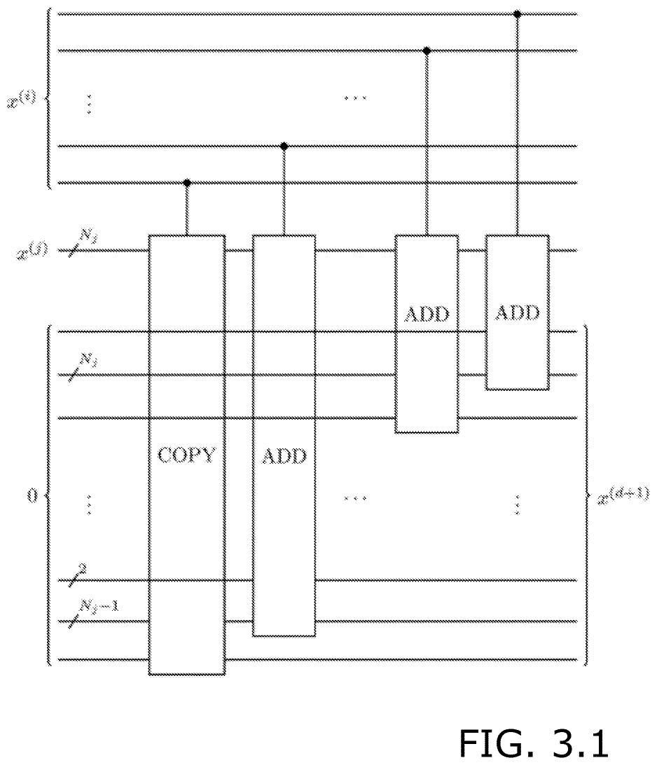

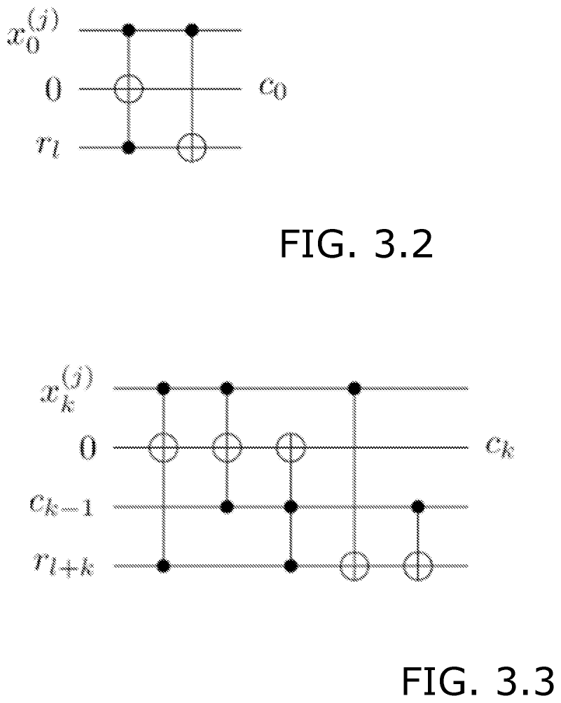

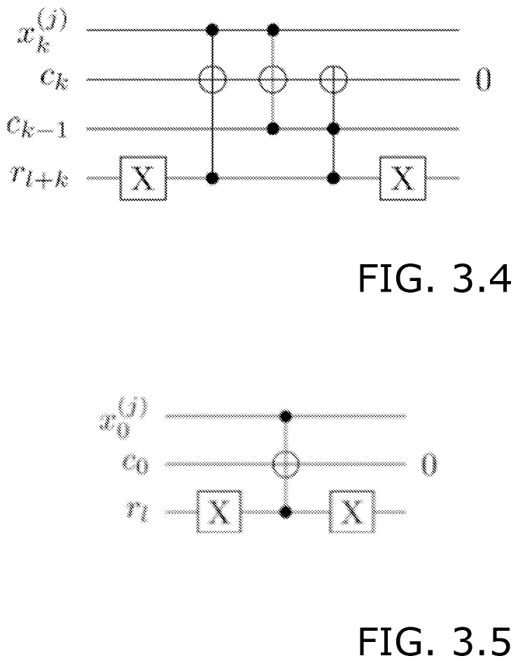

Once Nᵢ≥k>Nⱼ, the corresponding wire (which only ever acts as control) and any gates operating on this wire will be omitted resulting in a quantum circuit as depicted in FIG. 3.

The full summation circuit is given by working in ascending k≥1 and adding circuit blocks in turn. The output register x^{(d+1)} is initially set to zero. See also section 2.13 Optimisations below.

### 2.8—Reversible Multiplication

A circuit to take two registers, x⁽ⁱ⁾ and x^{(j)}, of sizes Nᵢ and Nⱼ respectively (where we let Nᵢ≥Nⱼ for simplicity) and outputs their multiplied value, denoted x^{(d+1)} (which has Nᵢ+Nⱼ bits). The output register x^{(d+1)} is initially set to zero.

To do this, we perform for each bit in dimension i the addition of the value in dimension j into the result register, conditioned on the value and shifted by the place of the bit in dimension i. We use Toffoli, CNOT and higher order controlled X gates to perform ‘in-place’ reversible sums, where each such gate is conditioned on the according qubit in the first register.

The high level overview of the multiplication as conditional additions is shown in the circuit diagram as shown in FIG. 3.1.

Except for the addition of the first qubit, which is a conditioned copy operation, we cannot assume that the previously affected qubits of the result register start in the 0 state. Due to the carry occurring for an initially non-empty result register, the affected range of the result register in each step is one bit wider than the number of bits of the second register.

The summation subcircuit can be implemented in more than one way, of which we present here two variations with different resource requirements. Note that in all the below circuit diagrams we always assume the additional control on a qubit of the dimension i to be given implicitly. This means that all depicted gates have an additional control on this qubit of dimension i, which is not shown.

2.9—Summation with Ancillas

Since the result register will not be empty except for the addition associated with the first bit, we use Nⱼ−1 ancillas in order to handle the carry in the binary addition. In order to minimise the number of ancillas, we reorder the registers so that Nᵢ≥Nⱼ.

Let x⁽ⁱ⁾ and x^{(j)} be two numbers to be multiplied to give x^{(d+1)}. For the addition of the first qubit of the dimension j, in which there is no previous carry qubit, the essential circuit is then as shown in FIG. 3.2 where l is the index of the qubit in dimension i, on which the above circuit is controlled.

All the following qubit additions do have a previous carry. The resulting circuit is as shown in FIG. 3.3.

The carry of the last qubit to be added will be reassigned as the most significant qubit of the result so far (thus increasing the size of the register r by one qubit), and will not be uncomputed in the following.

In order to be able to reuse the ancillas during the multiplication, as well as for subsequent operations, it is necessary to uncompute them. We do this in reversed order of the qubits of the first register, using the adjoint of the above addition circuits as part of the uncomputation circuits.

For uncomputing carry qubits cₖ, k≥1, the resulting circuit is performed in order of decreasing k as shown in FIG. 3.4.

Finally, for uncomputing cₖ, k=0, for which there is no previous carry. The resulting circuit is as shown in FIG. 3.5.

As per the original circuit, these summation blocks are performed in term for each qubit in the x⁽ⁱ⁾ register, and at the end the result in the register r is the multiplied value x^{(d+1)} as desired.

2.10—Summation without Ancillas

Here we describe a variation of the summation that does not need ancilla qubits. However the involved gates are controlled by a potentially high number of qubits, resulting in deep circuits when expressed as more basic Toffoli and CNOT gates.

For each qubit to be added first all carries are computed, starting from the most significant down to the least significant, into the result register. Only then the qubit is added with a CNOT gate acting on the according result qubit.

The circuit for adding the k^{th} qubit of dimension j, implicitly conditioned on the l^{th} qubit of dimension i, is given by depicted in FIG. 3.6.

### 2.11—Reversible Max/Min Determination

The conditions max(x⁽ⁱ⁾, x⁽ⁱ⁾) and min(x⁽ⁱ⁾, x⁽ⁱ⁾) lead to the appropriate one of the compared random variables being copied into a newly created dimension of the multivariate distribution. In order for the condition to be encoded in a summation circuit, one of the two values has to be inverted with X gates. If the dimensions have an unequal number of qubits (without loss of generality we can assume N_{d+1}≡Nᵢ≥Nⱼ as the dimensions can be switched accordingly), then the dimension with more qubits is inverted, so as to not lose the inversion of leading qubits.

After the uncomputation of the summation, there will be N_{d+1} free qubits which will take the greater/lesser of the two random variables as a result, depending on the control qubit (c≡r_{N}_{_{d+1}}₊₁).

The full circuit is depicted in FIG. 4 where the result is x^{(d+1)}=min(x⁽ⁱ⁾, x^{(j)}) and the value of the control qubit is c=1 if x⁽ⁱ⁾<x^{(j)} and c=0 if x⁽ⁱ⁾>x^{(j)}. Note that the summation circuit can be trivially inverted by reversing the order of the gates.

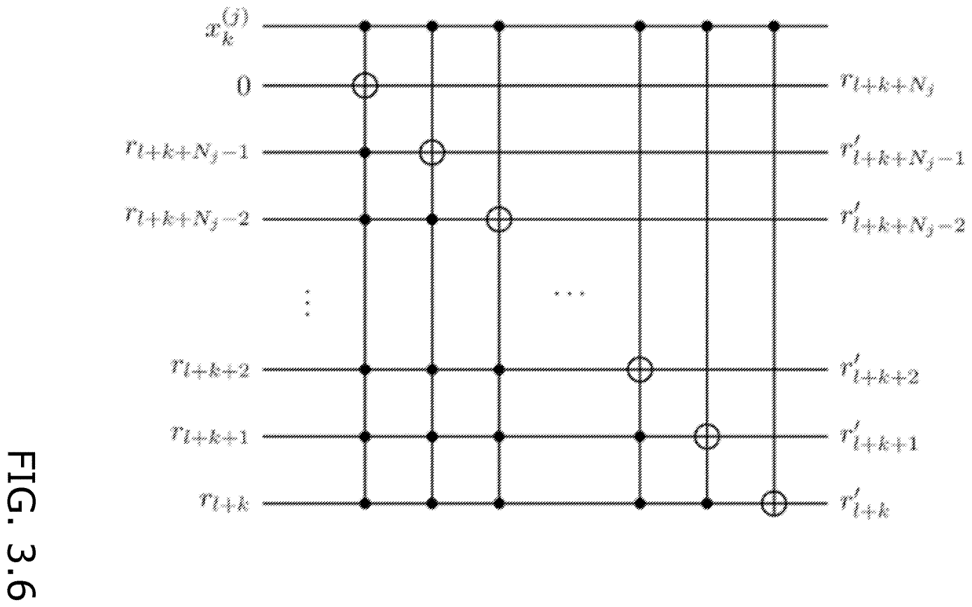

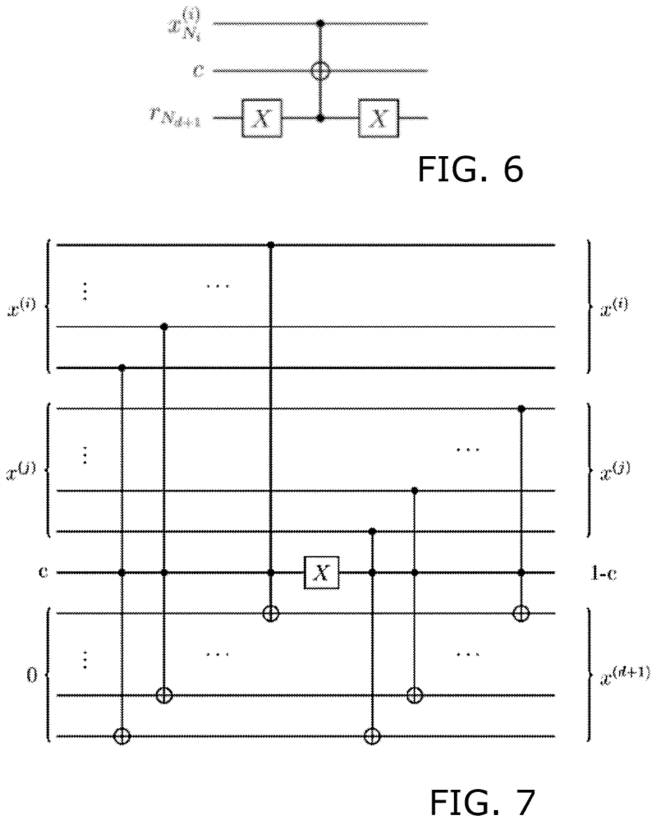

The summation circuit and its inverse are the same as for the summation operation. The circuits PRE for preserving the control qubit are depicted in FIG. 5 for N_{d+1}=Nᵢ=Nⱼ and depicted in FIG. 6 for N_{d+1}=Nᵢ>Nⱼ.

The COPY circuit for calculating the minimum is as depicted in FIG. 7 for the case Nᵢ=Nⱼ. For Nᵢ>Nⱼ the Toffoli gates connected to non-existing qubits are omitted. For calculating the maximum, the order of copying x⁽ⁱ⁾ and x^{(j)} is switched.

See also section 2.13 Optimisations below.

### 2.12—Reversible Threshold Determination

The threshold circuit is similar to the circuits for calculation of the maximum or minimum of two random variables. The notable difference is that the second value is a fixed classical value and therefore not encoded in a quantum register.

It is convenient to define the threshold value in the following way:
If the user specifies a lower-bound, this is taken as a strict inequality. The output will only be set to 1 if the value in the register strictly exceeds the threshold, and otherwise (if less than or equal) the output is 0.
If the user specifies an upper-bound, this is taken as an inequality that can be saturated, that is if the value in the register is less than or equal to the threshold then the output will be set to one; it will only be set to zero in the case that the upper-bound is strictly exceeded.
The idea is to use the above summation blocks to determine if a specified threshold is breached. However, since the threshold is a classical number, it does not need to be put into a register.
   Let the number being compared to the threshold be x⁽ⁱ⁾, a Nᵢ bit number.
   The threshold is inputted as a pure number, let this be T, and the first step is to convert this into a binary string, t, according to the x⁽ⁱ⁾ and Δ for the register in question. This binary string should be obtained by rounding T down. So when the binary string, t, is interpreted as a value \hat{T}≡xₗ+t·Δ according to xₗ and Δ, then this value should be less than or equal to T.
   Concretely

$$t = [ \frac{T - {x}_{l}}{Δ} ] ,$$

and consequently \hat{T}≤T<\hat{T}+Δ
We now obtain t′ as the one's complement of t according to: t′=2^{N}^{ᵢ}−1−t (note that here 2^{N}^{ᵢ}−1 is a binary string of Nᵢ ones). t′ is obtained classically.
t′ is itself a binary string of Nᵢ bits.

We now sum t′ and x⁽ⁱ⁾ to give an Nᵢ+1 bit number, r. The most significant bit c≡rₙ₊₁ will be set exactly if x⁽ⁱ⁾>t. For A≡xₗ+x⁽ⁱ⁾. Δ this is equivalent to A>\hat{T} or A>T.

Note that with these conventions, the value t=2^{N}^{ᵢ}−1⇔t′=0 yields a trivial condition, as the lower bound is never satisfied, whereas the upper bound always is. Useful threshold values are therefore xₗ≤T<xᵤ, yielding t∈{0, 1, . . . , 2^{N}^{ᵢ}−2}.

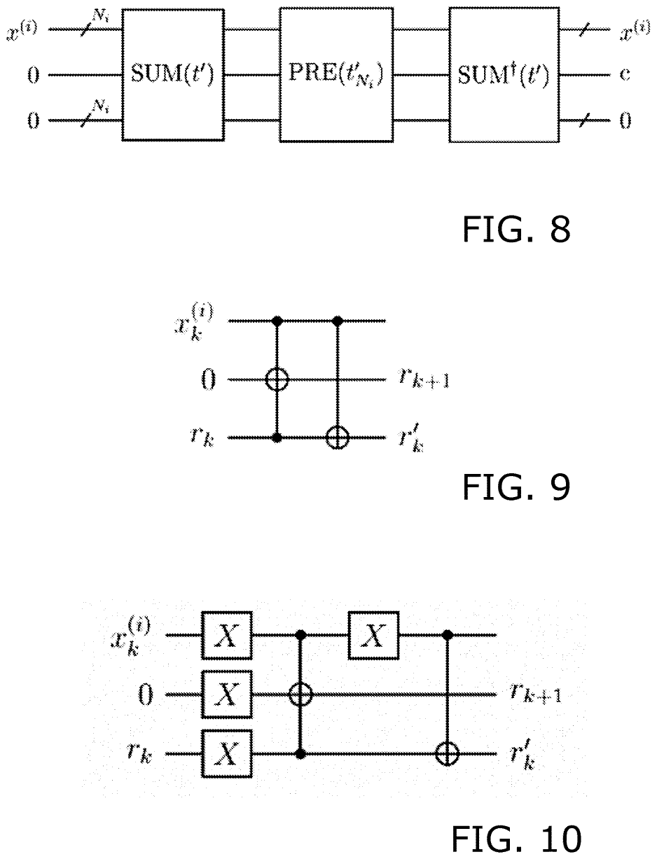

To achieve the threshold calculation, we can use the summation logic above, but without putting t′ into a register. The full circuit is given by a quantum circuit as depicted in FIG. 8 where the value of c is c=1 if x⁽ⁱ⁾t and c=0 if x⁽ⁱ⁾≤t. For an upper bound, the resulting threshold control qubit c is inverted with an X gate.

The circuits for adding an implicit binary digit are given by a quantum circuit as depicted in FIG. 9, for tₖ′=0 and given by the quantum circuit depicted in FIG. 10, for

$${t}_{k}^{′} = 1.$$

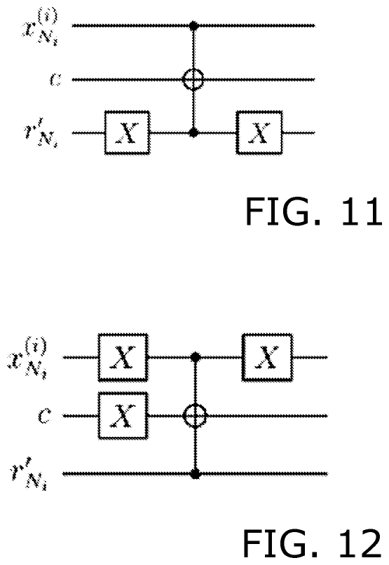

The most significant qubit of the result is the threshold control qubit. The other result qubits are “uncomputed” for reuse as ancillas. The uncomputation circuit is the reverse (adjoint) of the summation circuit, with a preservation circuit before that prevents the uncomputation of the threshold control qubit. The preservation circuits are similar to their counterparts in the Min-Max calculation, but with the second register omitted, since the threshold value is given implicitly. They are given by a quantum circuit as depicted in FIG. 11, for

$${t}_{k}^{′} = 0$$

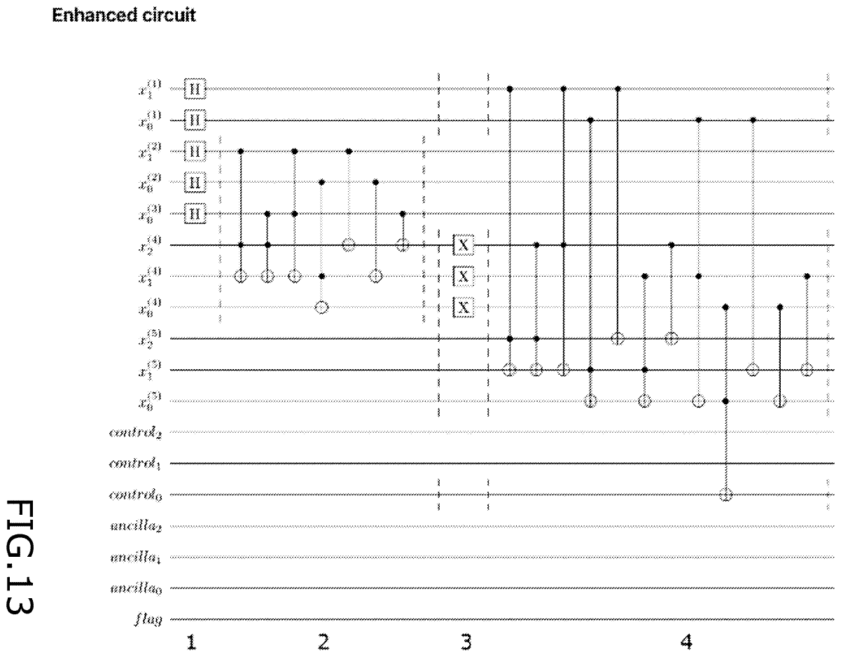

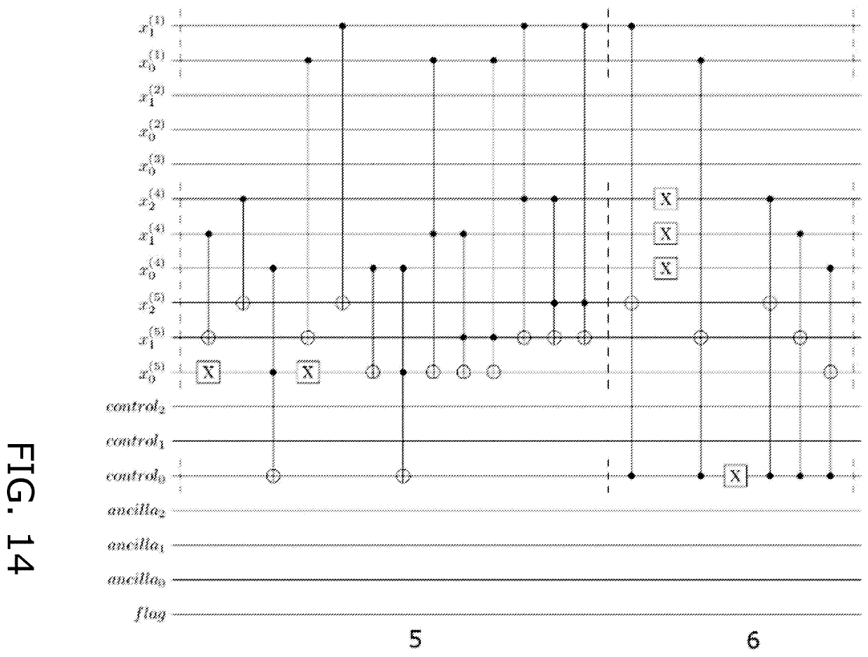

and a quantum circuit as depicted in FIG. 12, for

$${t}_{k}^{′} = 1.$$

Here c≡r_{N}_{ᵢ}₊₁ denotes the threshold control qubit.

Note that the total number of ancillas needed is the maximum number of ancillas over all threshold blocks, since they can be reused.

See also section 2.13 Optimisations below.

### 2.13—Optimisations

Various optimisations have been developed for the invention, as set out below.
If the thresholds are ordered in decreasing number of qubits then ancillas may be converted into controls of following thresholds.
Controlled operations at the beginning of a circuit can be removed if the incoming qubits are known to be in the 0 state. Examples of Reversible sum and Reversible threshold optimisation are described below.
   Reversible sum optimisation:
   An example optimised circuit for use in a Reversible sum operation is shown in FIG. 17. In addition to the circuits described in the above section “Reversible sum” and shown in FIG. 2 and FIG. 3, the fact that the qubits holding the result are initially in the 0 state can be used in an optimisation. For the first addition step (k=1), the circuit of FIG. 2 simplifies to that shown in FIG. 17.
   Reversible threshold optimisation
   Building on the Reversible sum optimisation described above, it is possible to further optimise the summation circuit in the Reversible threshold operation, taking into account that the incoming qubits are known to be in the 0 state. Moreover, since the classical threshold value t′ is known at the time of circuit construction, the operations without a preceding carry can comprise more than the first step. Starting from the least significant classical bit, for the first step and the following steps as long as the previous classical bit is 0, the previous addition cannot have yielded a carry. Then simplified versions of the circuits in FIG. 9 and FIG. 10 are used, which assume the previous carry to be 0. One simplified version for the classical bit t′ₖ=0 is shown in FIG. 19.1. A second version, for the classical bit t′ₖ=1, is shown in FIG. 19.2.
The conservation circuit can be merged with the adjoined summation circuit.
   Reversible max/min optimisation:
   Instead of inserting a preserving circuit (“conservation circuit”), the most significant qubit can be prevented from uncomputation by changing the uncomputation circuit SUM† and removing PRE from the circuit shown in FIG. 4 This amounts to the merging of the conservation circuit with the adjoined summation circuit. The changed circuit SUM† will be similar to the previous circuit, but the first uncomputation step will be different. The uncomputation circuit is therefore no longer the adjoint operation to SUM.
   For Nᵢ=Nⱼ=N_{d+1}−1, the circuit of FIG. 18.1 is used.
   For Nᵢ>Nⱼ, the circuit of FIG. 18.2 is used.
   Reversible threshold optimisation:
   As for the reversible max/min, also for the threshold the conservation circuit can be merged with the uncomputation circuit by changing the first uncomputation step. This amounts to a change of SUM† (t′) and removal of PRE(t′_{N}_{ᵢ}) from FIG. 8. The first uncomputation step is replaced with one of the circuits of FIG. 20.1 (for the classical bit

$${t}_{{N}_{i}}^{′} = 0 ,$$

where the classical bit is padded with 0) and 20.2

$$( for {t}_{{N}_{i}}^{′} = 1 ) .$$

If the same threshold value is used both as a lower and upper bound, then only one such threshold circuit is needed.
In the threshold circuit, the value x⁽ⁱ⁾ can be inverted with X gates, instead of the threshold value t. This might lead to a lower usage of X gates, depending on the threshold value and possibly compiler optimisation.
For the maximum/minimum circuit, the dimension with fewer qubits can be inverted, and the leading is can be summed implicitly as in the threshold circuit. This might result in a lower number of X gates used, again also dependent on compiler optimisation.
In a threshold circuit only as many qubits as are needed as ancillas/controls/flag for the following threshold circuits need to be uncomputed. The summation in the last threshold circuit does not need to be uncomputed, since the ancillas are not used again.
One of the ancillas of the threshold circuit can be reused as the flag qubit of the ESOP circuit.
Combining the above two ideas, just a single qubit of the summation in the last threshold circuit can be uncomputed (while leaving the others) to be reused as the flag qubit of the ESOP circuit.
If the flag qubit is not set, a rotation around the Y axis by i*θ is performed. By moving this rotation including the X gates to the right of the other rotation gates, the final X gave can be removed, since the final value of the flag qubit is irrelevant.

The multiplication of two dimensions can be easily extended to the case where the minimum points are not zero, but integer multiples of the respective spacing. Note that if

$${x}_{l}^{( i )} = {k}^{( i )} \cdot {Δ}^{( i )} and {x}_{l}^{( j )} = {k}^{( j )} \cdot {Δ}^{( j )}$$

then the product value of those two dimensions is (k⁽ⁱ⁾+x⁽ⁱ⁾)(k^{(j)}+x^{(j)})·Δ⁽ⁱ⁾·Δ^{(j)}. It follows that we get the desired result when the classical values k⁽ⁱ⁾ and k^{(j)} are added to their respective dimension before the multiplication.

### Example

This example showcases the above:
The Input is a circuit P=H^{⊗5} (that is, simply 5 Hadamard gates on 5 qubits), which is to be interpreted as a 3 dimensional probability distribution such that:
   x⁽¹⁾, x⁽²⁾ have 2 qubits,
   x⁽³⁾ has 1 qubit.
   For all, xₗ=0; Δ=1
Then we implement the following:
   Create a new dimension: x⁽⁴⁾=x⁽²⁾+x⁽³⁾
   Create a new dimension: x⁽⁵⁾=max(x⁽¹⁾, x⁽⁴⁾)
   Threshold 1: x⁽⁵⁾≤1
   Threshold 2: x⁽⁵⁾>2
   Flag true if: Threshold 1 xor Threshold 2 (note they cannot both we met, so xor has the same effect as or here)

Input and operations

```
# Underlying the 3-dimensional multivariate distribution is a 5-qubit circuit.
circuit = Circuit(5)
# The Hadamard gates provide for a uniform distribution in each dimension.
for qubit in circuit.qubits:
  circuit.H(qubit)
distribution = DistributionCircuit(
  circuit=circuit,
  wires=(2, 2, 1), # The number of qubits for each dimension
  x_l=0.0, # All dimensions share the same x_l
  delta=1.0, # All dimensions share the same Delta
)
# The operations are first a summation of the random variables in dimensions 2 and 3,
# putting the result in dimension 4. This is followed by calculating the maximum of the
# random variables in dimensions 1 and 4, putting the result in dimension 5.
operations = [Sum(2, 3), Max(1, 4)]
# The two thresholds are defined relative to dimension 5.
thresholds = [
  Threshold(dimension=5, value=1, type=BoundType.Upper),
  Threshold(dimension=5, value=2, type=BoundType.Lower),
]
# The ESOP is the exclusive sum of two threshold conditions, where the index ‘0’ refers
# to the first threshold defined above, and the index ‘1’ refers to the second. By
# virtue of the ‘True’, both conditions are satisfied if the respective threshold is
# satisfied.
esop = ESOP(
  [
    [(0, True)],
    [(1, True)],
  ]
)
# The enhanced distribution containing the enhanced circuit and dimensions is calculated
# by calling a function on an instance of the CircuitEnhancer class with the above
# enhancement parameters.
enhanced = circuit_enhancer.enhanced(
  distribution=distribution,
  operations=operations,
  thresholds= thresholds,
  esop=esop,
)
```

### 2.14—Enhanced Circuit

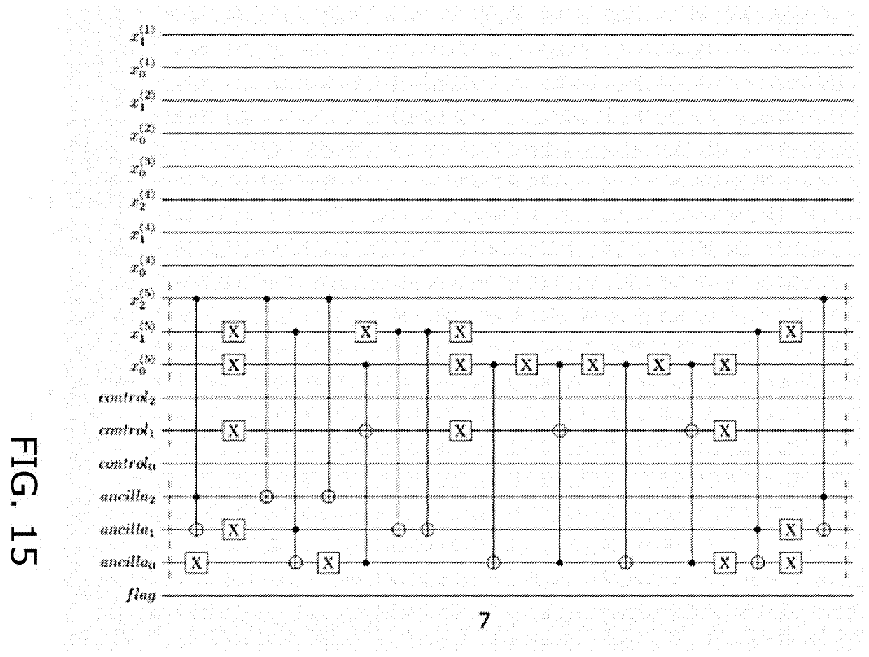

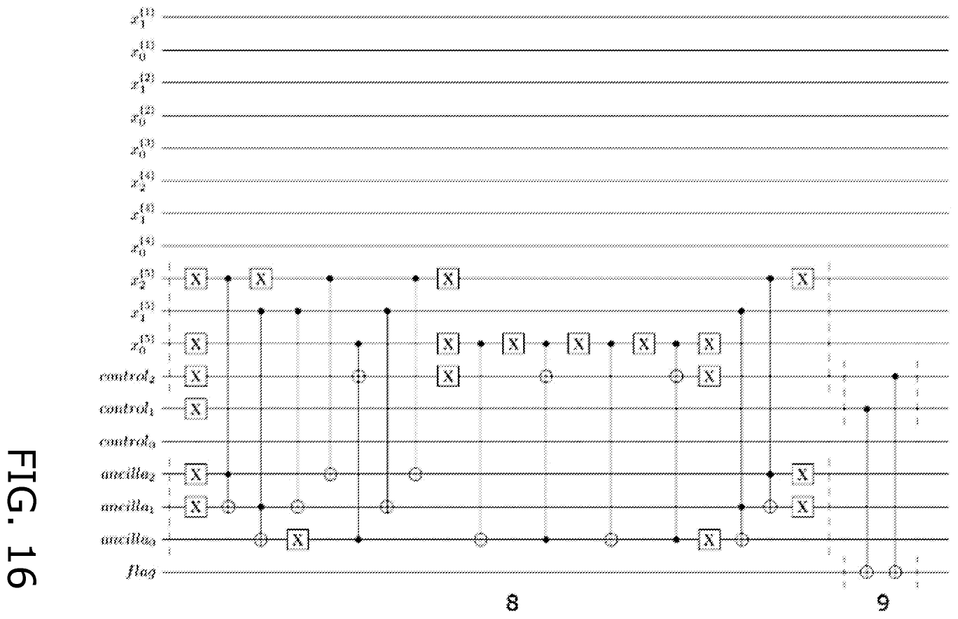

An enhanced circuit is depicted in FIG. 13, wherein:
1. The initial uniform distribution of the first 3 dimensions is prepared
2. The random variables x⁽²⁾ and x⁽³⁾ are added into dimension 4
3. As the first step of calculating the maximum of x⁽¹⁾ and x⁽⁴⁾, the latter is inverted
4. The random variables x⁽¹⁾ and the inverted x⁽⁴⁾ are added into dimension 5, with control₀ taking the information which one is greater
and wherein the enhanced circuit is further depicted in FIG. 14, wherein:
5. The previous summation is uncomputed, leaving the control qubit unaffected.
6. The inversion x⁽⁶⁾ is undone, and the greater value (according to the control qubit) is copied into dimension 5
and wherein the enhanced circuit is further depicted in FIG. 15, wherein:
7. The first threshold is computed, with control₁ taking the result.
The enhanced circuit is depicted in FIG. 16, wherein:
8. The second threshold is computed, with control₂ taking the result.
9. The ESOP of control₁ and control₂ is computed, with the flag qubit taking the result.

### 2.15—Output State

The output state is an equal superposition of 32 computational basis states, each represented as one line in the below output. The first tuple of each line contains the values of the 5 final dimensions, where the first 3 are the input, the fourth is the result of the summation, and the fifth is the result of the maximum calculation. The following tuple contains the 3 control qubits. The next number is the value of the 3 ancilla qubits, which is always 0. The final number is the flag qubit. Note that the values of the control qubits are inconsequential for the Monte Carlo Integration. The flag qubit indicates whether the ESOP threshold condition has been met.

| | |
|---|---|
| 1 | ((0, 0, 0, 0, 0), (1, 1, 0), 0, 1) |
| 2 | ((0, 0, 1, 1, 1), (1, 1, 0), 0, 1) |
| 3 | ((0, 1, 0, 1, 1), (1, 1, 0), 0, 1) |
| 4 | ((0, 1, 1, 2, 2), (1, 0, 0), 0, 0) |
| 5 | ((0, 2, 0, 2, 2), (1, 0, 0), 0, 0) |
| 6 | ((0, 2, 1, 3, 3), (1, 0, 1), 0, 1) |
| 7 | ((0, 3, 0, 3, 3), (1, 0, 1), 0, 1) |
| 8 | ((0, 3, 1, 4, 4), (1, 0, 1), 0, 1) |
| 9 | ((1, 0, 0, 0, 1), (0, 1, 0), 0, 1) |
| 10 | ((1, 0, 1, 1, 1), (1, 1, 0), 0, 1) |
| 11 | ((1, 1, 0, 1, 1), (1, 1, 0), 0, 1) |
| 12 | ((1, 1, 1, 2, 2), (1, 0, 0), 0, 0) |
| 13 | ((1, 2, 0, 2, 2), (1, 0, 0), 0, 0) |
| 14 | ((1, 2, 1, 3, 3), (1, 0, 1), 0, 1) |
| 15 | ((1, 3, 0, 3, 3), (1, 0, 1), 0, 1) |
| 16 | ((1, 3, 1, 4, 4), (1, 0, 1), 0, 1) |
| 17 | ((2, 0, 0, 0, 2), (0, 0, 0), 0, 0) |
| 18 | ((2, 0, 1, 1, 2), (0, 0, 0), 0, 0) |
| 19 | ((2, 1, 0, 1, 2), (0, 0, 0), 0, 0) |
| 20 | ((2, 1, 1, 2, 2), (1, 0, 0), 0, 0) |
| 21 | ((2, 2, 0, 2, 2), (1, 0, 0), 0, 0) |
| 22 | ((2, 2, 1, 3, 3), (1, 0, 1), 0, 1) |
| 23 | ((2, 3, 0, 3, 3), (1, 0, 1), 0, 1) |
| 24 | ((2, 3, 1, 4, 4), (1, 0, 1), 0, 1) |
| 25 | ((3, 0, 0, 0, 3), (0, 0, 1), 0, 1) |
| 26 | ((3, 0, 1, 1, 3), (0, 0, 1), 0, 1) |
| 27 | ((3, 1, 0, 1, 3), (0, 0, 1), 0, 1) |
| 28 | ((3, 1, 1, 2, 3), (0, 0, 1), 0, 1) |
| 29 | ((3, 2, 0, 2, 3), (0, 0, 1), 0, 1) |
| 30 | ((3, 2, 1, 3, 3), (1, 0, 1), 0, 1) |
| 31 | ((3, 3, 0, 3, 3), (1, 0, 1), 0, 1) |
| 32 | ((3, 3, 1, 4, 4), (1, 0, 1), 0, 1) |

### 2.16—System Architecture

FIG. 21 is a schematic representation of a hybrid computing system 100 including a classical (binary) digital computing apparatus 110 and a quantum computing apparatus 210. Each of the classical computing system 110 and the quantum computing system 210 may comprise one or more computing devices. The classical computer system 110 includes non-volatile data storage 120, at least one volatile memory 130 and at least one processor 140. A Quantum Monte Carlo Integration (QMCI) engine 150 is implemented as a computer program product stored within the non-volatile storage 120 and executable by the processor 140 to carry out a method for generating quantum circuits according to the invention, and for controlling interactions with the quantum computing apparatus. This includes control software for transferring a generated quantum circuit to the quantum computing system for execution. In particular, the QMCI includes a circuit builder module that is adapted to generate an enhanced quantum circuit for execution on the quantum computing apparatus to implement a set of operations applied to the dimensions of probability distributions, including maximum/minimum determinations, sum, multiplication and threshold determinations. The circuit builder module is integrated with a library of standardised circuits for preparing univariate and multivariate probability distributions, including normal, log-normal, and binomial distributions. This can provide the above-referenced first input data defining a quantum circuit P for encoding the target probability distribution onto a state of one or more qubits. The circuit builder module adds selected operators as additional circuitry to the standardised circuits, to perform the computations required by a user. This enables generation of quantum circuits for efficiently estimating properties of modelled complex quantum systems.

The steps of a method of generating a quantum circuit are shown in FIG. 22. The circuit builder module of the QMCI engine runs on the classical computing apparatus 110 and configures the processor 140 to generate quantum circuitry for a set of required operations, performing the steps of:
(i) receiving 300 first input data defining a quantum circuit P for encoding the target probability distribution onto a state of one or more qubits;
(ii) receiving 310 second input data defining the number of one or more dimensions (d) of the target probability distribution;
(iii) receiving 320 third input data defining a number of one or more qubits corresponding to each dimension of the d dimensions of the target probability distribution;
(iv) receiving 330 fourth input data defining a support for each dimension of the d dimensions of the target probability distribution;
(v) generating 340 from the first, second, third, and fourth data an enhanced form of the quantum circuit; and
(vi) outputting 350 data defining the enhanced quantum circuit.

As a further input to the computer system 100, user-defined instructions can specify required operations that can generate quantum circuitry, as described in detail above, to enhance a quantum state preparation circuit encoding some multivariate probability distribution, such that the circuit further includes dimensions pertaining to sums, products and maxima/minima of other dimensions, and optionally includes one or more further “flag” qubits that will act as conditional control in quantum Monte Carlo integration (QMCI).

The enhanced quantum circuit 220 is then implemented on the quantum computing apparatus, mapping 360 the logical qubits of the generated quantum circuit onto physical qubits 230 of the quantum computing apparatus 210, and the quantum circuit is then executed by manipulating these physical qubits to perform calculations such as a sum, a product, determination of maxima/minima and evaluation of threshold conditions. The quantum circuit as implemented on the quantum computing apparatus can be considered as analogous to a compiled program (low-level code) which has been adapted to run on the specific hardware implementation of the quantum computer, with an implementation taking account of the number and connectivity of the qubits and gates of the quantum computing apparatus. The results of these quantum computer calculations are output 370 to the classical computer system for evaluating properties of a whatever physical system or computational system the user has chosen to evaluate. The results of this analysis are provided as an output from the computing system 100.

### REFERENCES

[Ref1] S. Herbert, “Quantum monte-carlo integration: The full advantage in minimal circuit depth,” 2021. [Online]. Available: https://arxiv.org/abs/2105.09100
[Ref2] A. Montanaro, “Quantum speedup of monte carlo methods,” Proceedings of the Royal Society A: Mathematical, Physical and Engineering Sciences, vol. 471, no. 2181, p. 20150301, 2015. [Online]. Available: https://royalsocietypublishing.org/doi/abs/10.1098/rspa.2015.0301
[Ref3] S. Herbert, “Every classical sampling circuit is a quantum sampling circuit,” 2021. [Online]. Available: https://arxiv.org/abs/2109.04842

1. A computer implemented method for generating a quantum circuit for use by a quantum computing apparatus to prepare a state therein that encodes a target multivariate probability distribution, wherein the method includes steps of:
(i) receiving first input data defining a quantum circuit P for encoding the target probability distribution onto a state of one or more qubits;
(ii) receiving second input data defining the number of one or more dimensions (d) of the target probability distribution;
(iii) receiving third input data defining a number of one or more qubits corresponding to each dimension of the d dimensions of the target probability distribution;
(iv) receiving fourth input data defining a support for each dimension of the d dimensions of the target probability distribution;
(v) generating from the first, second, third, and fourth data an enhanced form of the quantum circuit; and
(vi) outputting data defining the enhanced quantum circuit;
wherein the sum of the numbers of qubits corresponding to each dimension is equal to the number of the one or more qubits of the state that the target probability distribution is encoded onto by circuit P, and wherein generating the enhanced quantum circuit in step (v) includes at least one of:
(a) generating additional quantum circuitry for the quantum circuit based on the input data of steps (i)-(iv) to sum random variables of the target probability distribution and to encode the sum as a new dimension of the multivariate distribution;
(b) generating additional quantum circuitry for the quantum circuit based on the input data of steps (i)-(iv) to calculate a product of a plurality of random variables of the target probability distribution and to encode the product as a new dimension of the multivariate distribution;
(c) generating additional quantum circuitry for the quantum circuit based on the input data of steps (i)-(iv) to calculate at least one of a maximum and a minimum of two correlated random variables represented as dimensions of the multivariate distribution and to encode each of the at least one of the maximum and minimum as a new dimension of the multivariate distribution; or
(d) generating additional threshold quantum circuitry for the quantum circuit based on the input data of step (i)-(iv) to check if a threshold condition is satisfied by a single random variable represented as one dimension of the multivariate distribution and to encode the result of the check on at least one extra truth qubit.

2. The method of claim 1, wherein step (d) of generating threshold quantum circuitry to check if a threshold condition is satisfied is performed for a plurality of different single random variables with a corresponding threshold condition and wherein step (v) of generating the enhanced quantum circuit further comprises:
generating additional threshold quantum circuitry for the quantum circuit based on the input data of step (i)-(iv) to add at least one further flag qubit, wherein the at least one further flag qubit is computed from an exclusive sum of products (ESOP) of each truth value of a plurality subset of the plurality of extra truth qubits.

3. The method of claim 1, wherein the quantum circuit P is configured for implementing quantum Monte Carlo integration (QMCI).

4. The method of claim 1, wherein there is a plurality of the dimensions (d).

5. The method of claim 1, wherein the summing in step (a) is implemented using a binary adder circuit.

6. The method of claim 1, wherein step (vi) also comprises outputting first additional data defining the number of dimensions of the enhanced multivariate distribution, including any new dimension of steps (a)-(d), and second additional data defining a number of one or more qubits corresponding to each dimension of the enhanced multivariate distribution, and third additional data defining a support for each dimension of the enhanced multivariate distribution.

7. A quantum computing apparatus configured to receive data defining the enhanced quantum circuit that is generated using the method of claim 1 and to implement the received enhanced quantum circuit.

8. A system for generating quantum circuits, the system comprising:
a memory; and
a processor, wherein the processor is configured to perform the steps of:
(i) receiving first input data defining a quantum circuit P for encoding the target probability distribution onto a state of one or more qubits;
(ii) receiving second input data defining the number of one or more dimensions (d) of the target probability distribution;
(iii) receiving third input data defining a number of one or more qubits corresponding to each dimension of the d dimensions of the target probability distribution;
(iv) receiving fourth input data defining a support for each dimension of the d dimensions of the target probability distribution;
(v) generating from the first, second, third, and fourth data an enhanced form of the quantum circuit; and
(vi) outputting data defining the enhanced quantum circuit;
wherein the sum of the numbers of qubits corresponding to each dimension is equal to the number of the one or more qubits of the state that the target probability distribution is encoded onto by circuit P, and wherein generating the enhanced quantum circuit in step (v) includes at least one of:
(a) generating additional quantum circuitry for the quantum circuit based on the input data of steps (i)-(iv) to sum random variables of the target probability distribution and to encode the sum as a new dimension of the multivariate distribution;
(b) generating additional quantum circuitry for the quantum circuit based on the input data of steps (i)-(iv) to calculate a product of a plurality of random variables of the target probability distribution and to encode the product as a new dimension of the multivariate distribution;
(c) generating additional quantum circuitry for the quantum circuit based on the input data of steps (i)-(iv) to calculate at least one of a maximum and a minimum of two correlated random variables represented as dimensions of the multivariate distribution and to encode each of the at least one of the maximum and minimum as a new dimension of the multivariate distribution; or
(d) generating additional threshold quantum circuitry for the quantum circuit based on the input data of step (i)-(iv) to check if a threshold condition is satisfied by a single random variable represented as one dimension of the multivariate distribution and to encode the result of the check on at least one extra truth qubit.

9. The system of claim 8, wherein step (d) of generating threshold quantum circuitry to check if a threshold condition is satisfied is performed for a plurality of different single random variables with a corresponding threshold condition and wherein step (v) of generating the enhanced quantum circuit further comprises:
generating additional threshold quantum circuitry for the quantum circuit based on the input data of step (i)-(iv) to add at least one further flag qubit, wherein the at least one further flag qubit is computed from an exclusive sum of products (ESOP) of each truth value of a plurality subset of the plurality of extra truth qubits.

10. The system of claim 8 wherein the quantum circuit P is configured for implementing quantum Monte Carlo integration (QMCI).

11. The system of claim 8, wherein there is a plurality of the dimensions (d).

12. The system of claim 8, wherein the additional quantum circuit includes a binary adder circuit for implementing summing in (a).

13. The system of claim 8, wherein step (vi) also comprises outputting first additional data defining the number of dimensions of the enhanced multivariate distribution, including any new dimension of steps (a)-(d), and second additional data defining a number of one or more qubits corresponding to each dimension of the enhanced multivariate distribution, and third additional data defining a support for each dimension of the enhanced multivariate distribution.

14. The system of claim 8 further comprising a quantum computing apparatus configured to receive from the processor the data defining the enhanced quantum circuit and to implement the enhanced quantum circuit based on the received data.

15. A software product that is executable upon a system for generating quantum circuits comprising a memory and a processor, to implement the method of claim 1.
